(19) United States
(12) Patent Application Publication
(10) Pub. No.: US 2025/0320095 A1
(43) Pub. Date: Oct. 16, 2025

(54) FORK ASSEMBLY AND WAREHOUSING ROBOT

(71) Applicant: HAI ROBOTICS CO., LTD., Shenzhen (CN)

(72) Inventors: Chenglong YANG, Shenzhen (CN); Demin XIU, Shenzhen (CN)

(73) Assignee: HAI ROBOTICS CO., LTD., Shenzhen (CN)

(21) Appl. No.: 19/238,008

(22) Filed: Jun. 13, 2025

Related U.S. Application Data
(63) Continuation of application No. PCT/CN2024/076184, filed on Feb. 5, 2024.

(30) Foreign Application Priority Data
Feb. 28, 2023 (CN) 202320460096.4

(51) Int. Cl. B66F 9/06; B66F 9/12; B66F 9/14

(52) U.S. Cl. CPC B66F 9/063; B66F 9/122; B66F 9/143; B66F 9/148

(57) ABSTRACT

A fork assembly includes a lifting beam, a traverse movement enabling mechanism, a mounting frame, and a fork body arranged on the mounting frame. The mounting frame is slidably mounted to the lifting beam. The traverse movement enabling mechanism is arranged between the mounting frame and the lifting beam. The traverse movement enabling mechanism is configured to drive the mounting frame to move along a first direction relative to the lifting beam, to adjust a distance between the fork body and a warehousing shelving unit.

### CROSS-REFERENCES

This application is a continuation of International Patent Application No. PCT/CN2024/076184 filed on Feb. 5, 2024, which claims priority to CN202320460096.4, filed on Feb. 28, 2023, the disclosures of which are incorporated herein by reference in their entireties.

### TECHNICAL FIELD

The present disclosure relates to the field of warehousing and logistics device technologies, and in particular, to a fork assembly and a warehousing robot.

### BACKGROUND OF THE INVENTION

With the development of the logistics industry, warehousing robots are gradually applied to a task of carrying goods, which can improve efficiency of goods carrying. Therefore, warehousing robots have become a research hotspot in the logistics industry.

A warehousing robot includes a fork assembly. The fork assembly includes a fork body and a telescopic arm arranged on the fork body. The telescopic arm is configured to grab a goods container, to achieve transfer of the goods container between the warehousing robot and a warehousing shelving unit. The warehousing robot generally moves along a guide line of an aisle to plan a movement path of the warehousing robot in the aisle. Since the guide line is usually arranged in the middle of the aisle, and the limitation by a rotation radius of the fork body, the warehousing robot can only move and operate in the aisle to which the warehousing robot is adapted, and cannot operate in an aisle of a different width, resulting in a poor adaptability.

### SUMMARY OF THE INVENTION

In view of the above problems, embodiments of the present disclosure provide a fork assembly and a warehousing robot, so that the warehousing robot can operate in an aisle of a different width to improve adaptability of the warehousing robot.

In order to achieve the foregoing objective, the embodiments of the present disclosure provide the following technical solutions.

A first aspect of the embodiments of the present disclosure provides a fork assembly, including a lifting beam, a traverse movement enabling mechanism, a mounting frame, and a fork body arranged on the mounting frame. The mounting frame is slidably mounted to the lifting beam, the traverse movement enabling mechanism is arranged between the mounting frame and the lifting beam, and the traverse movement enabling mechanism is configured to drive the mounting frame to move along a first direction relative to the lifting beam.

In an optional embodiment, the traverse movement enabling mechanism includes a first sliding rail and a first sliding block mated with the first sliding rail. The first sliding rail is arranged on a side wall of the lifting beam toward the mounting frame, and extends along the first direction. A side of the first sliding block is fixed to the mounting frame, and an other side of the first sliding block is slidably mounted to the first sliding rail.

In an optional embodiment, the traverse movement enabling mechanism further includes a first driving mechanism, a first pinion, and a first rack. The first driving mechanism is arranged on the mounting frame, and the first driving mechanism is drive-connected to the first pinion, and drives the first pinion to rotate. The first rack is arranged in parallel with the first sliding rail, and the first rack is located on a bottom wall of the lifting beam and is engaged with the first pinion.

In an optional embodiment, a rotating assembly is arranged between the fork body and the mounting frame. The fork body includes a bottom plate, and the rotating assembly includes a second driving mechanism, a rotary support bearing, a second pinion, a second rack, and a rotating base plate. The second driving mechanism is arranged on the mounting frame and is drive-connected to the second pinion. An outer ring of the rotary support bearing is fixed to the mounting frame, the second rack is arranged around an inner ring of the rotary support bearing, and the second rack is engaged with the second pinion. The rotating base plate is fixed to the inner ring of the rotary support bearing, and the fork body is connected to the rotating base plate through the bottom plate.

In an optional embodiment, the rotating assembly further includes a first limiting member and a second limiting member. The first limiting member and the second limiting member are spaced apart from each other on the inner ring of the rotary support bearing, and the first limiting member and the second limiting member are configured to abut against the mounting frame, to limit a rotation angle of the rotating assembly.

In an optional embodiment, the fork assembly further includes two telescopic arms and a variable width adjustment mechanism. The fork body further includes two side plates, and the two side plates are slidably mounted to two sides of the bottom plate along the first direction, and form an accommodating space. Each of the telescopic arms is arranged on a side wall of each of the side plates toward the accommodating space. The variable width adjustment mechanism is configured to move the two side plates toward or away from each other.

In an optional embodiment, the variable width adjustment mechanism includes a third driving mechanism and a variable width adjustment wheel set. The variable width adjustment wheel set includes a driving wheel, a driven wheel, and a first transmission belt. The driving wheel and the third driving mechanism are respectively arranged on the bottom plate, and located on an outer side of one of the side plates, and the third driving mechanism is drive-connected to the driving wheel and drives the driving wheel to rotate. The driven wheel is arranged on the bottom plate, and is located on an outer side of an other side plate, the driven wheel is arranged opposite to the driving wheel, and the first transmission belt is wrapped around the driving wheel and the driven wheel. The first transmission belt includes a first transmission section and a second transmission section that are opposite to each other. The first transmission section is configured to connect to one of the side plates, the second transmission section is configured to connect to the other side plate. When the third driving mechanism is in operation, the two side plates move toward or away from each other along the first direction.

In an optional embodiment, each of the telescopic arms includes a first telescopic arm plate and a second telescopic arm plate that slide relative to each other. The first telescopic arm plate is slidably mounted to an inner wall of the side plate, the first telescopic arm plate is provided with a flat belt wheel set, and the flat belt wheel set includes a first flat belt wheel, a second flat belt wheel, and a flat belt. The first flat belt wheel and the second flat belt wheel are respectively arranged on a front end and a rear end of the first telescopic arm plate along a second direction. The flat belt is wrapped around the first flat belt wheel and the second flat belt wheel, and the flat belt is connected to a rear end of the second telescopic arm plate. The two side plates are further each provided with a synchronous telescopic mechanism, and the synchronous telescopic mechanisms are configured to drive the two telescopic arms to operate synchronously.

In an optional embodiment, each of the side plates is provided with a first tensioning mechanism and a second tensioning mechanism. The flat belt includes a first end and a second end, and the first tensioning mechanism and the second tensioning mechanism are respectively connected to the first end and the second end of the flat belt, and are configured to synchronously adjust tightness of the flat belt.

In an optional embodiment, each of the synchronous telescopic mechanisms includes a fourth driving mechanism, a first synchronous wheel, a second synchronous wheel, and a second transmission belt. The first synchronous wheel and the second synchronous wheel are respectively arranged on two ends of the side plate, the second transmission belt is wrapped around the first synchronous wheel and the second synchronous wheel, and the second transmission belt is connected to the first telescopic arm plate. The fourth driving mechanism is drive-connected to the second transmission belt through a driving wheel, and drives the second transmission belt to rotate.

In an optional embodiment, the fork assembly further includes a telescopic tray assembly. The telescopic tray assembly includes an integrated mounting base, a tray frame, a tray, an elastic member, a second sliding rail, and a second sliding block. The integrated mounting base is fixed to the rotating base plate, the second sliding rail is arranged on the integrated mounting base along the second direction, the tray is fixed to the tray frame, and the tray frame is slidably mounted to the second sliding rail through the second sliding block. One end of the elastic member is connected to the integrated mounting base, and an other end of the elastic member is connected to a rear end of the tray frame and provides a driving force for the tray to move forward along the second direction.

In an optional embodiment, the telescopic tray assembly further includes a limiting block and a limiting plate.

The limiting block is arranged on the integrated mounting base and close to the second sliding rail, and the limiting block is configured to limit the second sliding block to limit movement of the tray.

The limiting plate is arranged on the rear end of the tray, and the limiting plate is configured for linkage with the telescopic arm, to cause the tray to move along the second direction when the telescopic arm moves along the second direction.

A second aspect of the embodiments of the present disclosure provides a warehousing robot, including a movable base, a lifting frame, and the fork assembly described in the first aspect. The lifting frame is mounted to the movable base, the fork assembly is slidably mounted to the lifting frame through a lifting beam thereof, and a height of the fork assembly is adjustable.

Compared with the related art, the warehousing robot provided in the embodiments of the present disclosure has the following advantages.

In the fork assembly of the warehousing robot provided in the embodiments of the present disclosure, the fork body is mounted to the mounting frame, and the mounting frame is slidably mounted to the lifting beam. The traverse movement enabling mechanism is arranged between the mounting frame and the lifting beam. The traverse movement enabling mechanism may cause the mounting frame to move transversely relative to the lifting beam.

Through such arrangement, when the warehousing robot operates in an aisle of a different width, the distance of the fork body relative to the warehousing shelving unit is adjusted through the traverse movement enabling mechanism, that is, a position of a rotation center of the fork body can be changed, so as to relieve a limitation of a rotation radius of the fork body on the warehousing robot during operation, so that the warehousing robot can operate in the aisle of the different width, thereby improving the adaptability of the warehousing robot.

In addition to the technical problems resolved through the embodiments of the present disclosure described above, the technical features constituting the technical solutions, and the beneficial effects brought about by the technical features of these technical solutions, other technical problems that can be resolved through the fork assembly and the warehousing robot provided in the embodiments of the present disclosure, other technical features included in the technical solutions, and the beneficial effects brought about by these technical features are to be further described in detail in detailed description.

### BRIEF DESCRIPTION OF DRAWINGS

In order to more clearly describe technical solutions in the embodiments of the present disclosure or in the prior art, the following briefly describes the accompanying drawings required for describing the embodiments or the prior art. Apparently, the accompanying drawings in the following description show some of the embodiments of the present disclosure, and a person of ordinary skill in the art may still derive other accompanying drawings from these accompanying drawings without any creative effort.

FIG. 1 is an isometric side view of a warehousing robot according to an embodiment of the present disclosure.

FIG. 2 is an isometric side view of a fork assembly according to an embodiment of the present disclosure.

FIG. 3 is a first schematic diagram of arrangement of a rotating assembly according to an embodiment of the present disclosure on a mounting frame, viewed from the bottom of the rotating assembly.

FIG. 4 is a second schematic diagram of arrangement of a rotating assembly according to an embodiment of the present disclosure on a mounting frame.

FIG. 5 is a schematic diagram of arrangement of a telescopic arm and a telescopic tray assembly on a fork body according to an embodiment of the present disclosure.

FIG. 6 is a schematic diagram of arrangement of a telescopic arm and a variable width adjustment mechanism on a fork body according to an embodiment of the present disclosure.

FIG. 7 is a schematic diagram of a telescopic arm according to an embodiment of the present disclosure from a first perspective.

FIG. 8 is a schematic diagram of a telescopic arm according to an embodiment of the present disclosure from a second perspective.

FIG. 9 is a schematic structural diagram of a flat belt wheel set according to an embodiment of the present disclosure.

FIG. 10 is a schematic structural diagram of a telescopic tray assembly according to an embodiment of the present disclosure.

FIG. 11 is a schematic diagram of connection between an integrated mounting base and a tray frame according to an embodiment of the present disclosure.

FIG. 12 is schematic structural diagram of a warehousing system.

### DESCRIPTION OF REFERENCE NUMERALS

10—Fork body; 11—Bottom plate; 111—guide rail; 12—Side plate; 121—sliding block;
20—Mounting frame;
30—Lifting beam; 31—side wall; 32—first bearing plate; 33—second bearing plate;
40—Traverse movement enabling mechanism;
41—First sliding rail; 42—First sliding block; 43—First driving mechanism; 44—First pinion; 45—First rack;
50—Rotating assembly;
51—Rotary support bearing; 510—outer ring; 511—inner ring; 52—Second pinion; 53—Second rack; 54—Rotating base plate; 55—Second driving mechanism;
60—Telescopic arm;
61—First telescopic arm plate; 62—Second telescopic arm plate;
63—Flat belt wheel set; 631—First flat belt wheel; 632—Second flat belt wheel; 633—Flat belt; 6331—first end; 6332—second end;
64—First tensioning mechanism; 65—Second tensioning mechanism;
70—Variable width adjustment mechanism;
71—Variable width adjustment wheel set; 711—Driving wheel; 712—Driven wheel; 713—First transmission belt; 7131—First transmission section; 7132—Second transmission section; 72—Third driving mechanism; 73—first connecting plate; 74—second connecting plate;
80—Synchronous telescopic mechanism;
81—First synchronous wheel; 82—Second synchronous wheel; 83—Second transmission belt; 84—Fourth driving mechanism;
90—Telescopic tray assembly;
91—Integrated mounting base; 92—Tray; 93—Second sliding rail; 94—Second sliding block; 95—Elastic member; 96—Limiting block; 97—Limiting plate; 98—Tray frame;
100—Fork assembly;
200—Lifting frame; 201—rack;
300—Movable base;
400—walking mechanism; 401—walking wheel;
500—warehousing shelving unit;
600—aisle;
700—goods container.

### DETAILED DESCRIPTION

As described in the background art, the warehousing robot can only move and operate in the aisle to which the warehousing robot is adapted, and cannot operate in an aisle of a different width, resulting in a problem of poor adaptability. The inventor found through research that a reason for this problem is that the warehousing robot generally moves along a guide line of an aisle to plan a movement path of the warehousing robot in the aisle. Since the guide line is usually arranged in a middle position of the aisle along a width direction of the aisle, and a fork body cannot be adjusted in the width direction of the aisle, a distance between a current fork body and a warehousing shelving unit cannot be adjusted, that is, a rotation radius of the fork body is limited, which affects operation of the warehousing robot.

For example, a distance between a code reading camera on a fork assembly of the warehousing robot and a goods container needs to be less than a recognition distance of the code reading camera, so that it can be ensured that the code reading camera operates normally. However, when the warehousing robot operates in the aisle of the different width, once the distance between the code reading camera and the goods container exceeds the recognition distance of the code reading camera, the code reading camera cannot operate normally, which affects the operation of the warehousing robot.

In view of the above technical problem, embodiments of the present disclosure provide a fork assembly and a warehousing robot. In the fork assembly thereof, the fork body is mounted to a mounting frame, and the mounting frame is slidably mounted to a lifting beam. A traverse movement enabling mechanism is arranged between the mounting frame and the lifting beam. The traverse movement enabling mechanism may cause the mounting frame to move transversely relative to the lifting beam.

Through such arrangement, when the warehousing robot operates in an aisle of a different width, the distance of the fork body relative to the warehousing shelving unit is adjusted through the traverse movement enabling mechanism, that is, a position of a rotation center of the fork body can be changed, so as to relieve a limitation of a rotation radius of the fork body on the warehousing robot during operation, so that the warehousing robot can operate in the aisle of the different width, thereby improving the adaptability of the warehousing robot.

For example, when the warehousing robot operates in an aisle of a different width, a distance of the fork assembly relative to the warehousing shelving unit is adjusted through the traverse movement enabling mechanism, so that the distance between the code reading camera and the goods container can be adjusted. In this way, the code reading camera can recognize the goods container, and then cause the warehousing robot to operate in the aisle of the different width, thereby improving the adaptability of the warehousing robot.

In order to make the objectives, features, and advantages of the embodiments of the present disclosure more apparent and easier to understand, the technical solutions of the embodiments of the present disclosure are to be clearly and completely described below with reference to the accompanying drawings in the embodiments of the present disclosure. Apparently, the described embodiments are merely some of the embodiments of the present disclosure, but not all of the embodiments. All other embodiments obtained by a person of ordinary skilled in the art based on the embodiments of the present disclosure without creative efforts shall fall within the protection scope of the present disclosure.

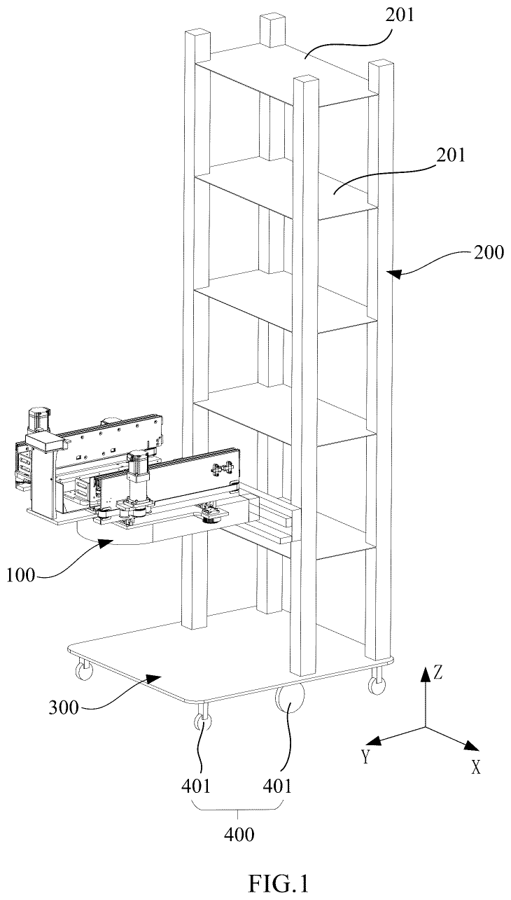

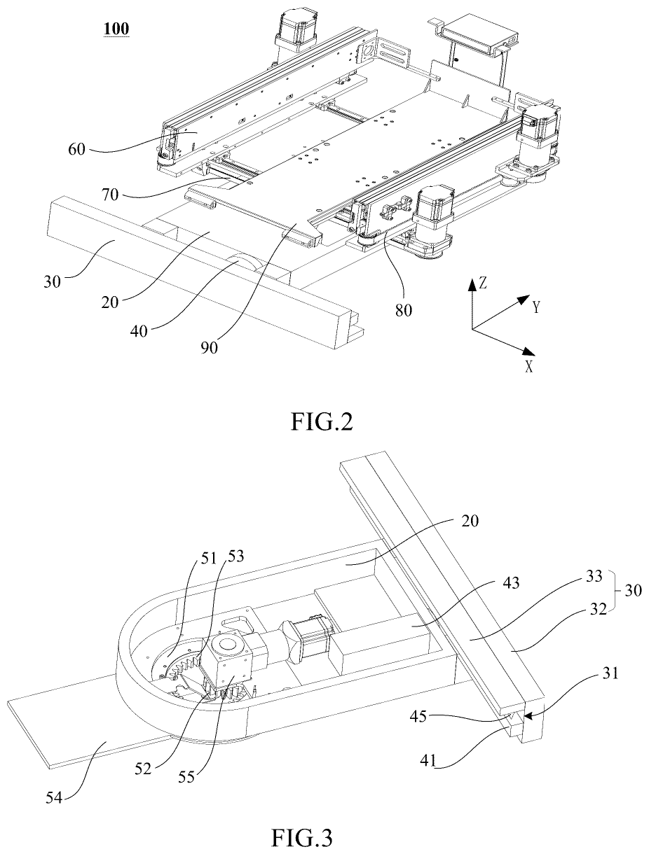

For ease of description of the embodiments of the present disclosure, a coordinate system of the warehousing robot in the state shown in FIG. 1 and FIG. 2 is first defined, where an X-axis direction is a first direction, which is defined as a relative arrangement direction of two side plates, a Y-axis direction is a second direction, which is defined as a stretching or retraction direction of a telescopic arm, and a Z-axis direction is a third direction, which is defined as a height direction of the warehousing robot, or a movement direction of a fork assembly 100 relative to a lifting frame 200. It should be understood that the X-axis direction is a width direction of the aisle, and the relative arrangement direction of two side plates refers to the relative arrangement direction of two side plates when the fork assembly faces a lifting frame 200. The Y-axis direction is a direction perpendicular to the X-axis direction and extending in a horizontal plane. The stretching or retraction direction of a telescopic arm refers to a stretching or retraction direction of the telescopic arm when the fork assembly faces the lifting frame 200.

As shown in FIG. 1, the warehousing robot provided in the embodiments of the present disclosure includes a movable base 300, a walking mechanism 400, a lifting frame 200, and a fork assembly 100. The walking mechanism 400 is arranged below the movable base 300, and is configured to drive the movable base 300 to move.

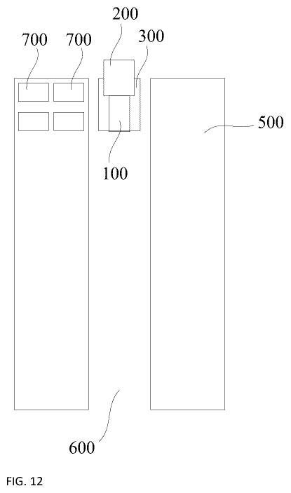

The walking mechanism 400 includes a plurality of walking wheels 401 and a driving apparatus (not shown). The driving apparatus is configured to provide a driving force for each of the walking wheels 401 to cause the walking wheels 401 to rotate relative to the ground. For example, the driving apparatus is configured as a driving motor connected to at least one walking wheel 401, and provides a driving force for the walking wheel 401, so as to enable the movable base 300 to move forward, backward, turn, and the like, so that the warehousing robot moves to a warehousing shelving unit 500 (as shown in FIG. 12) or another operation position, thereby completing transfer of goods. It should be noted that, the goods in the embodiments of the present disclosure may be a goods container 700 containing materials, which is used as an example for description in the embodiments of the present disclosure.

The lifting frame 200 is mounted to the movable base 300 in a vertical state, and the lifting frame 200 is provided with a plurality of racks 201 at intervals along a third direction, to temporarily store the goods container 700. The fork assembly 100 is configured to grab the goods container. The fork assembly 100 is slidably mounted to a side of the lifting frame 200, and can move up or down along a height direction of the lifting frame 200 under the action of a lifting force, to adjust an operation height of the fork assembly 100, and then complete retrieval or storage of goods containers 700 located at different heights on the warehousing shelving unit 500. For example, the warehousing robot may transfer the goods container 700 on the warehousing shelving unit 500 to the fork assembly 100, and further temporarily store the goods container 700 in the rack 201, or transfer the goods container 700 in the rack 201 onto the warehousing shelving unit 700.

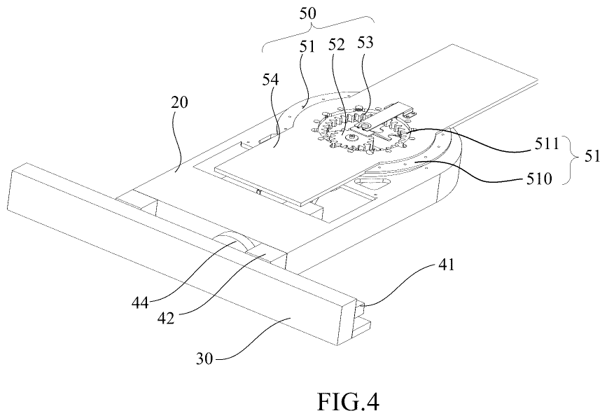

As shown in FIG. 2 to FIG. 4, the fork assembly 100 in the embodiments of the present disclosure includes a fork body 10, a mounting frame 20, a lifting beam 30, and a traverse movement enabling mechanism 40. The mounting frame 20 is configured to bear the fork body 10 and each driving mechanism (not shown). The fork body 10 is rotatably connected to the mounting frame 20. The fork body 10 is rotatable relative to the mounting frame 20 under the action of the driving mechanism.

A position of the mounting frame 20 relative to the lifting frame 200 in the first direction is adjustable. The lifting beam 30 is arranged between the mounting frame 20 and the lifting frame 200. An end of the mounting frame 20 is slidably mounted to the lifting beam 30, and can move along the first direction relative to the lifting beam 30. The lifting beam 30 is slidably mounted to the lifting frame 200, and moves up or down along the third direction relative to the lifting frame 200, and then the fork body 10 may move up or down along the third direction relative to the lifting frame 200, and may move transversely along the first direction relative to the lifting frame 200.

The traverse movement enabling mechanism 40 is arranged between the mounting frame 20 and the lifting beam 30. The traverse movement enabling mechanism 40 can provide a sliding force for the mounting frame 20, to drive the mounting frame 20 to move along the first direction relative to the lifting beam 30. Exemplarily, the traverse movement enabling mechanism 40 includes a first sliding rail 41 and a first sliding block 42 mated with the first sliding rail 41. The first sliding rail 41 is arranged on a side wall 31 of the lifting beam 30 toward the mounting frame 20, and an extension direction of the first sliding rail 41 is consistent with the first direction.

The first sliding block 42 is arranged on an end of the mounting frame 20 close to the lifting beam 30, and is fixed to the mounting frame 20. The mounting frame 20 is slidably mounted to the first sliding rail 41 through the first sliding block 42. The mounting frame 20 is movable along the first sliding rail 41 under the action of an external sliding force.

In one implementation, the traverse movement enabling mechanism 40 includes an actuating cylinder. The actuating cylinder is arranged on the lifting beam 30, and the actuating cylinder may be arranged on an end of the lifting beam 30 along the first direction. The actuating cylinder is connected to the mounting frame 20, and can provide a sliding force for the mounting frame 20, to cause the mounting frame 20 to slide on the lifting beam 30 along the first direction.

In another implementation, the traverse movement enabling mechanism 40 includes a first driving mechanism 43, a first pinion 44, and a first rack 45. The first driving mechanism 43 may be a first driving motor, and the first driving mechanism 43 is arranged on the mounting frame 20. For example, the first driving mechanism 43 is arranged on a bottom of the mounting frame 20 and close to the lifting beam 30.

The first rack 45 is arranged on the lifting beam 30 and is located on a bottom wall of the lifting beam 30. The first rack 45 extends along the first direction and is arranged parallel to the first sliding rail 41. The first rack 45 is engaged with the first pinion 44. The first pinion 44 is connected to the first driving mechanism 43. The first driving mechanism 43 drives the first pinion 44 to rotate, and drives the entire mounting frame 20 to move along the first rack 45.

For example, the lifting beam 30 is L-shaped as a whole. The lifting beam 30 includes a first bearing plate 32 and a second bearing plate 33. The second bearing plate 33 is located on a bottom of the first bearing plate 32 along the third direction, and is located on a side of the first bearing plate 32 close to the mounting frame 20. The first bearing plate 32 is slidably mounted to the lifting frame 200, and the first bearing plate 32 is configured to allow mounting of the first sliding rail 41. The first rack 45 is arranged on the second bearing plate 33 and engaged with the first pinion 44.

Compared with the solution in the related art that the fork body cannot be adjusted in the width direction of the aisle, resulting in that the distance between the current fork body and the warehousing shelving unit cannot be adjusted, that is, the rotation radius of the fork body is limited, thereby affecting the operation of the warehousing robot, the warehousing robot provided in the embodiments of the present disclosure adjusts the distance of the fork body 10 relative to the warehousing shelving unit 500 through the traverse movement enabling mechanism 40 when operating in an aisle 600 of a different width, that is, can change the position of the rotation center of the fork body 10, so that the fork body 10 may adjust the position of the rotation center thereof in the width direction of the aisle 600, thereby relieving the limitation of the rotation radius of the fork body 10 on the warehousing robot during operation, and then the warehousing robot can operate in the aisle 600 of the different width, thereby improving the adaptability of the warehousing robot.

For example, the fork body is provided with a code reading camera for recognizing a goods container. The code reading camera is arranged directly facing the warehousing shelving unit during goods retrieval by the warehousing robot, and is located on an end of the fork body close to the warehousing shelving unit. The code reading camera can recognize a two-dimensional code or the like of a to-be-taken or to-be-placed goods container, which may be for example arranged on a front end of the fork body 10 along the second direction (along a stretching direction of a telescopic arm 60).

The distance between the code reading camera of the warehousing robot and the goods container needs to be less than the recognition distance of the code reading camera, so that it can be ensured that the code reading camera operates normally. However, when the warehousing robot operates in the aisle of the different width, once the distance between the code reading camera and the goods container exceeds the recognition distance of the code reading camera, the code reading camera cannot operate normally.

When the warehousing robot provided in the embodiments of the present disclosure operates in the aisle of the different width, the distance of the fork assembly relative to the warehousing shelving unit is adjusted through the traverse movement enabling mechanism, so that the distance between the code reading camera and the goods container can be adjusted. In this way, the code reading camera can recognize the goods container, and then cause the warehousing robot to operate in the aisle of the different width, thereby improving the adaptability of the warehousing robot.

Still referring to FIG. 3 to FIG. 5, based on the foregoing embodiments, the fork assembly 100 in the embodiments of the present disclosure further includes a rotating assembly 50. The rotating assembly 50 is arranged between the fork body 10 and the mounting frame 20. The fork body 10 includes a bottom plate 11. The bottom plate 11 is connected to the mounting frame 20 through the rotating assembly 50, and is rotatable relative to the mounting frame 20 under the action of a rotating force. Through such arrangement, the fork assembly 100 can further rotate relative to the lifting frame 200, thereby enhancing operation efficiency thereof.

Exemplarily, the rotating assembly 50 includes a second driving mechanism 55, a rotary support bearing 51, a second pinion 52, a second rack 53, and a rotating base plate 54. The second driving mechanism 55 includes a second driving motor and a speed reducer connected to the second driving motor, and an output shaft of the speed reducer is drive-connected to the second pinion 52 and drives the second pinion 52 to rotate.

Further, an outer ring 510 of the rotary support bearing 51 is fixed to the mounting frame 20. The second rack 53 is arranged around an inner ring 511 of the rotary support bearing 51, that is, the second rack 53 may be an annular rack. The second pinion 52 is located in the second rack 53 and engaged with the second rack 53. When the second pinion 52 rotates, the inner ring 511 of the rotary support bearing 51 may be driven to rotate relative to the mounting frame 20.

The rotating base plate 54 is arranged above the rotary support bearing 51 and is connected to the inner ring 511 of the rotary support bearing 51, so that the rotating base plate 54 rotates together with the inner ring 511 of the rotary support bearing 51. For example, when the fork assembly 100 places the goods container on the warehousing shelving unit, the second driving mechanism 55 operates to drive the rotating base plate 54 and the fork body 10 to rotate. When the fork body rotates to a preset angle, the front end of the fork body 10 is opposite to the warehousing shelving unit, and the goods container is further placed from the rack on the warehousing shelving unit. This process may be defined as rotation of the fork assembly 100 from a first position to a second position, that is, the fork assembly 100 is in an operating location.

Accordingly, the second driving mechanism 55 continuously operates and causes the fork assembly 100 to rotate reversely, so that the front end of the fork body 10 is opposite to the rack 201 of the warehousing robot, and may further take the goods container from the rack 201. This process is defined as rotation of the fork assembly 100 from the second position to the first position, that is, the fork assembly 100 is reset and returned to zero. Conversely, the goods container on the warehousing shelving unit is transferred to the warehousing robot. The rotation process of the fork assembly 100 is similar to the foregoing process, and details are not described again.

Through such arrangement, the fork assembly 100 in the embodiments of the present disclosure can decouple the fork body 10 from the rotating assembly 50 by independently arranging the rotating assembly 50, that is, the rotating assembly 50 is designed as a general-purpose module, so that the rotating assembly 50 may be universal for different models, which also facilitates maintenance and saves costs.

Based on the foregoing embodiments, the rotating assembly 50 in the embodiments of the present disclosure further includes a first limiting member and a second limiting member. The first limiting member and the second limiting member are spaced apart from each other on the inner ring of the rotary support bearing 51. The mounting frame 20 is provided with a limiting portion, and the limiting portion is located on a rotation path of the first limiting member and the second limiting member, and can abut against the first limiting member and the second limiting member, so as to limit a rotation angle of the fork assembly 100.

For example, the first limiting member and the second limiting member may be limiting screws. When the first limiting member abuts against the limiting portion of the mounting frame 20, the fork assembly 100 rotates from the second position to the first position in this case, that is, when the first limiting member abuts against the limiting portion 21, the fork assembly 100 is reset and returned to zero.

The fork assembly 100 rotates reversely. When the second limiting member abuts against the mounting portion, the fork assembly 100 rotates from the first position to the second position in this case, that is, when the second limiting member abuts against the limiting portion, the fork assembly 100 is in the operating location.

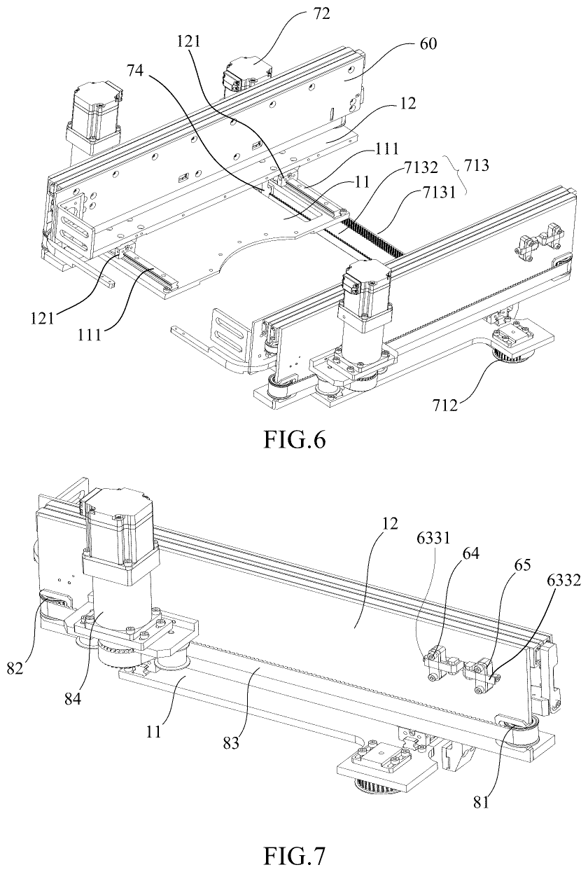

As shown in FIG. 2 and FIG. 5 to FIG. 7, based on the foregoing embodiments, the fork assembly 100 in the embodiments of the present disclosure further includes two telescopic arms 60 and a variable width adjustment mechanism 70. Correspondingly, the fork body 10 further includes two side plates 12. The two side plates 12 are arranged on two sides of the bottom plate 11 along the first direction, and an accommodating space is formed between the bottom plate 11 and the two side plates 12. The accommodating space is configured for temporary storage of a goods container.

The two telescopic arms 60 are slidably mounted to a side wall of each of the two side plates 12. For example, each of the telescopic arms 60 is slidably mounted to an inner side wall of the side plate 12 toward the accommodating space, and the telescopic arm 60 can slide along the second direction relative to the side plate 12 to stretch or retract the telescopic arm 60. The above variable width adjustment mechanism 70 is configured to cause the two side plates 12 to move toward or away from each other along the first direction, thereby adjusting a width between the two side plates 12.

For example, the bottom plate 11 is provided with two guide rails 111 at an interval along the second direction, and each guide rail 111 extends along the first direction. The two side plates 12 are each provided with a sliding block 121 mated with the guide rail 111, so that the side plate 12 is slidably mounted to the guide rail 111. When the variable width adjustment mechanism 70 operates, the two side plates 12 may move toward or away from each other along the first direction, to adjust the width between the two side plates 12, and further adjust a width between the two telescopic arms 60, so that the fork assembly 100 is applicable to retrieval or storage of goods containers of different widths. It should be noted that, it is when the front end fork body 10 faces the lifting frame 200, the two side plates 12 are driven by the variable width adjustment mechanism 70 to move toward or away from each other along the first direction. When the front end fork body 10 faces the warehouse shelf unit, the two side plates 12 are driven by the variable width adjustment mechanism 70 to move toward or away from each other along the second direction.

The variable width adjustment mechanism 70 in the embodiments of the present disclosure includes a third driving mechanism 72 and a variable width adjustment wheel set 71. The variable width adjustment wheel set 71 includes a driving wheel 711, a driven wheel 712, and a first transmission belt 713. The driving wheel 711 is mounted to a back side of the bottom plate 11 through a bracket. The driving wheel 711 is drive-connected to the third driving mechanism 72, and the third driving mechanism 72 and the driving wheel 711 are both arranged on an outer side of one of the side plates 12. The third driving mechanism 72 includes at least a third driving motor. The second driving motor is configured to provide a driving force for the driving wheel 711. The driving wheel 711 may rotate relative to the bottom plate 11 under the driving force of the third driving motor.

Further, the driven wheel 712 is mounted to the back side of the bottom plate 11 through a bracket, and the driven wheel 712 is located on an outer side of the other side plate 12. The driven wheel 712 is arranged relative to the driving wheel 711. The first transmission belt 713 is wrapped around the driving wheel 711 and the driven wheel 712, thereby ensuring that the driving wheel 711 and the driven wheel 712 rotate synchronously.

The first transmission belt 713 includes a first transmission section 7131 and a second transmission section 7132 that are opposite to each other. The first transmission section 7131 and the second transmission section 7132 are connected end to end. The first transmission section 7131 is connected to one of the side plates 12, and the second transmission section 7132 is connected to the other side plate 12, so that when the first transmission belt 713 rotates in operation of the third driving mechanism 72, the two side plates 12 are caused to move toward or away from each other.

For example, the variable width adjustment mechanism 70 in the embodiments of the present disclosure further includes a first connecting plate 73 and a second connecting plate 74. The first connecting plate 73 is configured to connect to one of the side plates 12 and the first transmission section 7131. The second connecting plate 74 is configured to connect to the other side plate 12 and the second transmission section 7132.

The first transmission belt 713 includes transmission teeth. One end of the first connecting plate 73 is engaged with and fixed to the transmission teeth of the first transmission section 7131, and an other end of the first connecting plate 73 is fixed to the side plate 12. Similarly, one end of the second connecting plate 74 is engaged with and fixed to the transmission teeth of the second transmission section 7132, and an other end of the second connecting plate 74 is fixed to the side plate 12. Through such arrangement, reliability of connection between the first transmission belt 713 and the first connecting plate 73 and the second connecting plate 74, and force transmission stability may be improved.

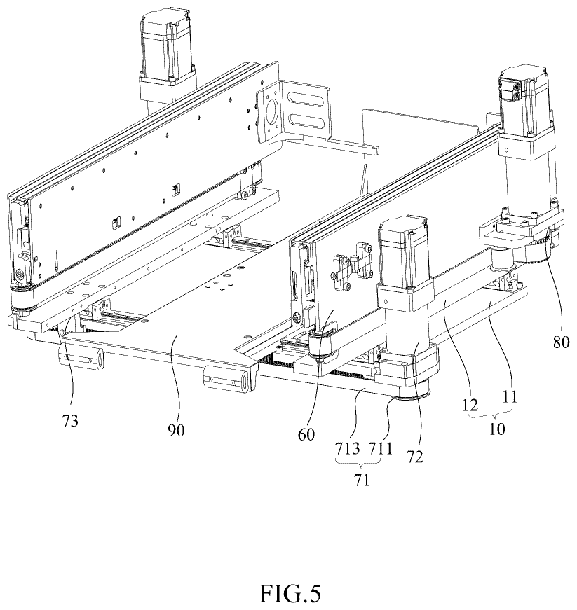

Based on the foregoing embodiments, as shown in FIG. 5 to FIG. 8, each of the two side plates 12 is further provided with a synchronous telescopic mechanism 80. The synchronous telescopic mechanism 80 is configured to drive the two telescopic arms 60 to operate synchronously. Exemplarily, each of the synchronous telescopic mechanisms 80 includes a fourth driving mechanism 84, a first synchronous wheel 81, a second synchronous wheel 82, and a second transmission belt 83. The first synchronous wheel 81 and the second synchronous wheel 82 are respectively arranged on a front end and a rear end of each side plate 12 along the second direction, and the second transmission belt 83 is wrapped around the first synchronous wheel 81 and the second synchronous wheel 82.

Further, the fourth driving mechanism 84 includes at least a fourth driving motor. The fourth driving motors operate synchronously. The fourth driving mechanism 84 is drive-connected to the second transmission belt 83. In operation, the fourth driving mechanism 84 drives the second transmission belt 83 to rotate. The second transmission belt 83 in this embodiment is connected to the above telescopic arm 60, which may further drive the telescopic arm 60 to move relative to the side plate 12 along the second direction, so that the telescopic arm 60 stretches or retracts.

For example, the fourth driving mechanism 84 further includes a driving wheel connected to the fourth driving motor. The driving wheel and the second transmission belt 83 transmit a driving force through transmission teeth, that is, the driving wheel and the second transmission belt 83 respectively have transmission teeth that are engaged with each other. Correspondingly, an outer peripheral wall of each of the first synchronous wheel 81 and the second synchronous wheel 82 is also provided with transmission teeth engaged with the second transmission belt 83. Further, the above fourth driving mechanism 84 is vertically arranged, and is drive-connected to the second transmission belt 83 through the driving wheel. Through such arrangement, this layout facilitates replacement of the second transmission belt 83.

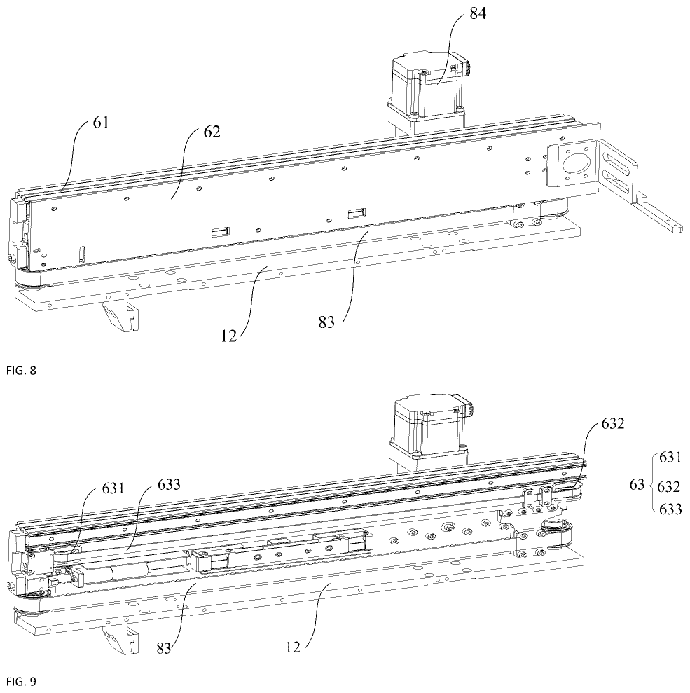

As shown in FIG. 8 and FIG. 9, each telescopic arm 60 in the embodiments of the present disclosure includes a first telescopic arm plate 61 and a second telescopic arm plate 62. The first telescopic arm plate 61 is slidably connected to the inner side wall of the side plate 12, and the second telescopic arm plate 62 is slidably connected to the first telescopic arm plate 61, that is, the first telescopic arm plate 61 and the second telescopic arm plate 62 are slidably connected relative to each other.

Further, the first telescopic arm plate 61 is provided with a flat belt wheel set 63. The flat belt wheel set 63 includes a first flat belt wheel 631, a second flat belt wheel 632, and a flat belt 633. The first flat belt wheel 631 and the second flat belt wheel 632 are spaced apart from each other on a front end and a rear end of the first telescopic arm plate 61 along the second direction, the flat belt 633 is wrapped around the first flat belt wheel 631 and the second flat belt wheel 632, and the flat belt 633 is fixedly connected to the rear end of the first telescopic arm plate 61.

The first telescopic arm plate 61 is connected to the second transmission belt 83 of the synchronous telescopic mechanism 80. When the second transmission belt 83 rotates, the first telescopic arm plate 61 moves following the second transmission belt 83, which can move relative to the side plate 12 along the second direction. Accordingly, the second telescopic arm plate 62 moves relative to the first telescopic arm plate 61, thereby realizing a two-stage telescopic movement of the telescopic arm 60. In addition, the second telescopic arm plate 62 moves at a 2× speed relative to the first telescopic arm plate 61, thereby enhancing moving efficiency of the telescopic arm 60.

Based on the foregoing embodiments, each side plate 12 is further provided with a first tensioning mechanism 64 and a second tensioning mechanism 65. The first tensioning mechanism 64 and the second tensioning mechanism 65 are arranged on a front end of the first telescopic arm plate 61, and partially located outside the side plate 12, so as to facilitate operation of each tensioning mechanism and adjust tightness of the flat belt 633.

For example, the flat belt 633 includes a first end 6331 and a second end 6332 that are opposite to each other. The first end 6331 of the flat belt 633 is wrapped around the first flat belt wheel 631 and connected to the first tensioning mechanism 64. The second end 6332 of the flat belt 633 is wrapped around the second flat belt wheel 632 and connected to the second tensioning mechanism 65. The second tensioning mechanism 65 and the first tensioning mechanism 64 are spaced apart from each other, and the first tensioning mechanism 64 and the second tensioning mechanism 65 adjust the flat belt 633 in opposite directions. Through such arrangement, two ends of the flat belt 633 may be adjusted synchronously through the first tensioning mechanism 64 and the second tensioning mechanism 65, to increase a utilization rate of the flat belt 633.

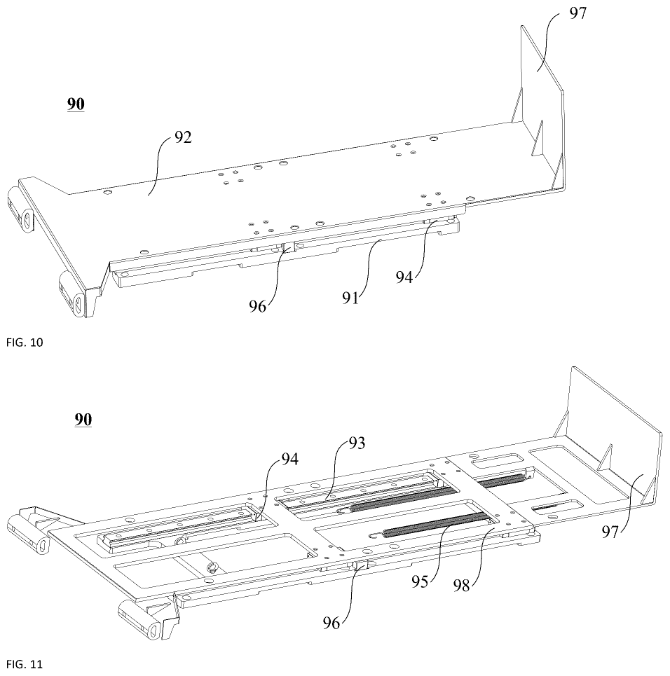

As shown in FIG. 10 and FIG. 11, the fork assembly 100 in the embodiments of the present disclosure further includes a telescopic tray assembly 90. The telescopic tray assembly 90 is arranged on the bottom plate 11 and configured to bear a goods container. The telescopic tray assembly 90 includes an integrated mounting base 91 and a tray frame 98, a tray 92, and an elastic member 95 mounted to the integrated mounting base 91. The integrated mounting base 91 is fixed to the rotating base plate 54, so that the entire telescopic tray assembly 90 is mounted to the rotating base plate 54 in an integrated manner, that is, the telescopic tray assembly 90 may be modularized, pre-assembled, and easy to maintain and replace.

Further, a surface of the integrated mounting base 91 away from the rotating base plate 54 is provided with a second sliding rail 93, and the second sliding rail 93 is provided with a second sliding block 94 mated with the second sliding rail 93. The second sliding rail 93 extends along the second direction, that is, a length direction of the second sliding rail 93 is consistent with the second direction. The tray frame 98 is slidably mounted to the second sliding rail 93 through the second sliding block 94, and the tray frame 98 is configured to allow mounting of the tray 92.

One end of the above elastic member 95 is connected to the integrated mounting base 91, an other end of the elastic member 95 is connected to a rear end of the tray frame 98, and the elastic member 95 is in a stretched state, and can provide a sliding force for the tray frame 98 toward a front end of the integrated mounting base 91 along the second direction.

Further, the telescopic tray assembly 90 further includes a limiting block 96 and a limiting plate 97. The limiting block 96 is arranged on the integrated mounting base 91 and close to the second sliding rail 93. The limiting block 96 may be located on a movement path of the second sliding block 94, so that the limiting block 96 can limit the second sliding block 94 to limit movement of the tray frame 98. Through such arrangement, not only the tray frame 98 can be prevented from being detached from the second sliding rail 93, but also the movement of the tray 92 can be limited or reasonably designed.

The limiting plate 97 is arranged on a rear end of the tray 92. For example, the limiting plate 97 may be designed as an integral structure with the tray 92 or the tray frame 98. The limiting plate 97 is configured for linkage with the telescopic arm 60. When the telescopic arm 60 does not move relative to the side plate 12, the tray 92 is limited and cannot move along the second direction. When the telescopic arm 60 moves along the second direction relative to the side plate 12, the limitation of the tray 92 is removed in this case, and the tray 92 may move along the second direction.

For example, the second telescopic arm plate 62 of the telescopic arm 60 is provided with a finger motor and a limiting arm connected to the finger motor. When the finger motor operates, the limiting arm rotates to a horizontal state toward the accommodating space, and an end of the limiting arm can abut against the limiting plate 97. In this case, the tray 92 is in a state of being limited, and an elastic force of the elastic member 95 cannot cause the tray 92 to move along the second direction.

Conversely, when the telescopic arm 60 stretches forward along the second direction, the tray 92 has a free displacement to move forward. Therefore, the tray 92 may move forward under the elastic force of the elastic member 95. In addition, when the telescopic arm 60 retracts, the limiting arm abuts against the limiting plate 97, and overcomes the elastic force of the elastic member 95 to reset the tray 92.

The embodiments or the implementations in this specification are described in a progressive manner. Each embodiment focuses on the differences from other embodiments, and for the same and similar parts between the embodiments, reference may be made to each other.

It should be noted that “one embodiment”, “embodiment”, “exemplary embodiment”, “some embodiments”, and the like mentioned in this specification indicate that the embodiment may include a particular feature, structure, or characteristic, but not every embodiment includes the particular feature, structure, or characteristic. Moreover, such phrases do not necessarily refer to the same embodiment. Furthermore, when the particular feature, structure, or characteristic is described according to the embodiment, implementation of such a feature, structure, or characteristic according to another embodiment that is explicitly or not explicitly described is within the knowledge scope of a person skilled in the art.

In general, a term should be understood at least in part by use in context. For example, at least in part by context, a term “one or more” used herein may be configured to describe any feature, structure, or characteristic in the singular, or may be configured to describe a combination of features, structures, or characteristics in the plural. Similarly, at least in part by context, a term such as “a” or “the” may further be understood to convey singular usage or plural usage.

In addition, for convenience of description, spatially relative terms may be used herein, for example, “underneath”, “below”, “beneath”, “over”, and “above”, to describe a relationship of one element or feature relative to another element or feature as shown in the figure. The spatially relative terms are intended to encompass different orientations of a device in use or operation other than the orientation shown in the accompanying drawing. An apparatus may have another orientation (rotated by 90 degrees or located in another orientation), and the spatially relative descriptors used herein may also be interpreted accordingly.

Finally, it should be noted that the foregoing embodiments are merely used for describing the technical solutions of the present disclosure, rather than limiting the present disclosure. Although the present disclosure is described in detail with reference to the foregoing embodiments, a person of ordinary skill in the art should understand that modifications may still be made to the technical solutions described in the foregoing embodiments, or equivalent replacements may be made to some or all of the technical features. However, these modifications or replacements do not make the essence of corresponding technical solutions depart from the scope of the technical solutions of the embodiments of the present disclosure.

1. A fork assembly, comprising a lifting beam, a traverse movement enabling mechanism, a mounting frame, and a fork body arranged on the mounting frame; and
the mounting frame is slidably mounted to the lifting beam, the traverse movement enabling mechanism is arranged between the mounting frame and the lifting beam, and the traverse movement enabling mechanism is configured to drive the mounting frame to move along a first direction relative to the lifting beam.

2. The fork assembly according to claim 1, wherein the traverse movement enabling mechanism comprises a first sliding rail and a first sliding block mated with the first sliding rail;
the first sliding rail is arranged on a side wall of the lifting beam toward the mounting frame, and extends along the first direction; and
a side of the first sliding block is fixed to the mounting frame, and an other side of the first sliding block is slidably mounted to the first sliding rail.

3. The fork assembly according to claim 2, wherein the traverse movement enabling mechanism further comprises a first driving mechanism, a first pinion, and a first rack;
the first driving mechanism is arranged on the mounting frame, and the first driving mechanism is drive-connected to the first pinion, and drives the first pinion to rotate; and
the first rack is arranged in parallel with the first sliding rail, and the first rack is located on a bottom wall of the lifting beam and is engaged with the first pinion.

4. The fork assembly according to claim 1, wherein a rotating assembly is arranged between the fork body and the mounting frame;
the fork body comprises a bottom plate, the rotating assembly comprises a second driving mechanism, a rotary support bearing, a second pinion, a second rack, and a rotating base plate, and the second driving mechanism is arranged on the mounting frame and is drive-connected to the second pinion;
an outer ring of the rotary support bearing is fixed to the mounting frame, the second rack is arranged around an inner ring of the rotary support bearing, and the second rack is engaged with the second pinion; and
the rotating base plate is fixed to the inner ring of the rotary support bearing, and the fork body is connected to the rotating base plate through the bottom plate.

5. The fork assembly according to claim 4, wherein the rotating assembly further comprises a first limiting member and a second limiting member; and
the first limiting member and the second limiting member are spaced apart from each other on the inner ring of the rotary support bearing, and the first limiting member and the second limiting member are configured to abut against the mounting frame, to limit a rotation angle of the rotating assembly.

6. The fork assembly according to claim 4, further comprising two telescopic arms and a variable width adjustment mechanism;
the fork body further comprises two side plates, and the two side plates are slidably mounted to two sides of the bottom plate along the first direction, and form an accommodating space; and
each of the telescopic arms is arranged on a side wall of each of the side plates toward the accommodating space, and the variable width adjustment mechanism is configured to move the two side plates toward or away from each other.

7. The fork assembly according to claim 6, wherein the variable width adjustment mechanism comprises a third driving mechanism and a variable width adjustment wheel set;
the variable width adjustment wheel set comprises a driving wheel, a driven wheel, and a first transmission belt, the driving wheel and the third driving mechanism are respectively arranged on the bottom plate, and located on an outer side of one of the side plates, and the third driving mechanism is drive-connected to the driving wheel and drives the driving wheel to rotate;
the driven wheel is arranged on the bottom plate, and is located on an outer side of an other side plate, the driven wheel is arranged opposite to the driving wheel, and the first transmission belt is wrapped around the driving wheel and the driven wheel; and
the first transmission belt comprises a first transmission section and a second transmission section that are opposite to each other, the first transmission section is configured to connect to one of the side plates, the second transmission section is configured to connect to the other side plate, and when the third driving mechanism is in operation, the two side plates move toward or away from each other along the first direction.

8. The fork assembly according to claim 6, wherein each of the telescopic arms comprises a first telescopic arm plate and a second telescopic arm plate that slide relative to each other;
the first telescopic arm plate is slidably mounted to an inner wall of the side plate, the first telescopic arm plate is provided with a flat belt wheel set, and the flat belt wheel set comprises a first flat belt wheel, a second flat belt wheel, and a flat belt;
the first flat belt wheel and the second flat belt wheel are respectively arranged on a front end and a rear end of the first telescopic arm plate along a second direction, the flat belt is wrapped around the first flat belt wheel and the second flat belt wheel, and the flat belt is connected to a rear end of the second telescopic arm plate; and
each of the two side plates is further provided with a synchronous telescopic mechanism, and the synchronous telescopic mechanisms are configured to drive the two telescopic arms to operate synchronously.

9. The fork assembly according to claim 8, wherein each of the side plates is provided with a first tensioning mechanism and a second tensioning mechanism; and
the flat belt comprises a first end and a second end, and the first tensioning mechanism and the second tensioning mechanism are respectively connected to the first end and the second end of the flat belt, and are configured to synchronously adjust tightness of the flat belt.

10. The fork assembly according to claim 8, wherein each of the synchronous telescopic mechanisms comprises a fourth driving mechanism, a first synchronous wheel, a second synchronous wheel, and a second transmission belt;
the first synchronous wheel and the second synchronous wheel are respectively arranged on two ends of the side plate, the second transmission belt is wrapped around the first synchronous wheel and the second synchronous wheel, and the second transmission belt is connected to the first telescopic arm plate; and
the fourth driving mechanism is connected to the second transmission belt through a driving wheel, and drives the second transmission belt to move.

11. The fork assembly according to claim 6, further comprising a telescopic tray assembly, wherein
the telescopic tray assembly comprises an integrated mounting base, a tray frame, a tray, an elastic member, a second sliding rail, and a second sliding block, the integrated mounting base is fixed to the rotating base plate, the second sliding rail is arranged on the integrated mounting base along the second direction, the tray is fixed to the tray frame, and the tray frame is slidably mounted to the second sliding rail through the second sliding block; and
one end of the elastic member is connected to the integrated mounting base, and an other end of the elastic member is connected to a rear end of the tray frame and provides a driving force for the tray to move forward along the second direction.

12. The fork assembly according to claim 11, wherein the telescopic tray assembly further comprises a limiting block and a limiting plate;
the limiting block is arranged on the integrated mounting base and close to the second sliding rail, and the limiting block is configured to limit the second sliding block to limit movement of the tray; and
the limiting plate is arranged on the rear end of the tray, and the limiting plate is configured for linkage with the telescopic arm, to cause the tray to move along the second direction when the telescopic arm moves along the second direction.

13. A warehousing robot, comprising:
a movable base;
a lifting frame mounted to the movable base; and
a fork assembly comprising:
a lifting beam mounted to the lifting frame, and being capable of moving up or down relative to the lifting frame;
a traverse movement enabling mechanism, arranged on the lifting beam;
a mounting frame connected to the traverse movement enabling mechanism, the mounting frame being capable of sliding along the traverse movement enabling mechanism in a horizontal direction; and
a fork body arranged on the mounting frame, the fork body being configured to retrieve or place goods.

14. The warehousing robot according to claim 13, wherein the traverse movement enabling mechanism comprises a first sliding rail and a first sliding block mated with the first sliding rail;
the first sliding rail is arranged on a side wall of the lifting beam toward the mounting frame, and extends along the first direction; and
a side of the first sliding block is fixed to the mounting frame, and an other side of the first sliding block is slidably mounted to the first sliding rail.

15. The warehousing robot according to claim 14, wherein the traverse movement enabling mechanism further comprises a first driving mechanism, a first pinion, and a first rack;
the first driving mechanism is arranged on the mounting frame, and the first driving mechanism is drive-connected to the first pinion, and drives the first pinion to rotate; and
the first rack is arranged in parallel with the first sliding rail, and the first rack is located on a bottom wall of the lifting beam and is engaged with the first pinion.

16. The warehousing robot according to claim 13, wherein a rotating assembly is arranged between the fork body and the mounting frame;
the fork body comprises a bottom plate, the rotating assembly comprises a second driving mechanism, a rotary support bearing, a second pinion, a second rack, and a rotating base plate, and the second driving mechanism is arranged on the mounting frame and is drive-connected to the second pinion;
an outer ring of the rotary support bearing is fixed to the mounting frame, the second rack is arranged around an inner ring of the rotary support bearing, and the second rack is engaged with the second pinion; and
the rotating base plate is fixed to the inner ring of the rotary support bearing, and the fork body is connected to the rotating base plate through the bottom plate.

17. The warehousing robot according to claim 16, wherein the rotating assembly further comprises a first limiting member and a second limiting member; and
the first limiting member and the second limiting member are spaced apart from each other on the inner ring of the rotary support bearing, and the first limiting member and the second limiting member are configured to abut against the mounting frame, to limit a rotation angle of the rotating assembly.

18. The warehousing robot according to claim 16, further comprising two telescopic arms and a variable width adjustment mechanism;
the fork body further comprises two side plates, and the two side plates are slidably mounted to two sides of the bottom plate along the first direction, and form an accommodating space; and
each of the telescopic arms is arranged on a side wall of each of the side plates toward the accommodating space, and the variable width adjustment mechanism is configured to move the two side plates toward or away from each other.

19. The warehousing robot according to claim 18, wherein the variable width adjustment mechanism comprises a third driving mechanism and a variable width adjustment wheel set;
the variable width adjustment wheel set comprises a driving wheel, a driven wheel, and a first transmission belt, the driving wheel and the third driving mechanism are respectively arranged on the bottom plate, and located on an outer side of one of the side plates, and the third driving mechanism is drive-connected to the driving wheel and drives the driving wheel to rotate;
the driven wheel is arranged on the bottom plate, and is located on an outer side of an other side plate, the driven wheel is arranged opposite to the driving wheel, and the first transmission belt is wrapped around the driving wheel and the driven wheel; and
the first transmission belt comprises a first transmission section and a second transmission section that are opposite to each other, the first transmission section is configured to connect to one of the side plates, the second transmission section is configured to connect to the other side plate, and when the third driving mechanism is in operation, the two side plates move toward or away from each other along the first direction.

20. A fork assembly comprising:
a lifting beam;
a traverse movement enabling mechanism arranged on the lifting beam, the traverse movement enabling mechanism comprises a first sliding rail extending in a horizontal direction, and a first sliding block mated with the first sliding rail, a side of the sliding block is slidably mounted to the first sliding rail;
a mounting frame connected to an other side of the sliding block away from the first sliding rail, the mounting frame being capable of sliding along the traverse movement enabling mechanism in the horizontal direction when the sliding block slides on the first sliding rail; and
a fork body arranged on the mounting frame, the fork body being configured to retrieve or place goods.
